(19) United States
(12) Patent Application Publication
(10) Pub. No.: US 2017/0343125 A1
(43) Pub. Date: Nov. 30, 2017

(54) FUEL PASSAGE STRUCTURES

(71) Applicant: AISAN KOGYO KABUSHIKI KAISHA, Obu-shi (JP)

(72) Inventors: Hiroyuki TAKAHASHI, Nagoya-shi (JP); Takashi KANIE, Toyoake-shi (JP)

(73) Assignee: AISAN KOGYO KABUSHIKI KAISHA, Obu-shi (JP)

(21) Appl. No.: 15/601,031

(22) Filed: May 22, 2017

(30) Foreign Application Priority Data
May 24, 2016 (JP) 2016-103530

(51) Int. Cl. F16K 21/04; F02M 37/04; F02M 37/00; F16K 15/00; F02D 33/00

(52) U.S. Cl. CPC F16K 21/04; F16K 15/00; F02D 33/00; F02M 37/0023; F02M 37/04

(57) ABSTRACT

A fuel passage structure of a fuel supply device is configured to supply fuel from a fuel tank to an internal combustion engine. The fuel passage structure includes a passage-forming member that forms a fuel passage and a check valve. The fuel passage includes a vertical passage extending in a vertical direction and a lateral passage extending in a horizontal direction. The check valve is disposed at an intersection of the vertical passage and the lateral passage. The check valve includes a valve body configured to close under its own weight. The valve body is movably arranged within the vertical passage in the vertical direction. The check valve is provided with a restriction member which restricts movement of the valve body into the lateral passage, while at the same time the restriction member does not disturb the forward flow of the pressurized fuel.

### CROSS-REFERENCE TO RELATED APPLICATIONS

This application claims priority to Japanese patent application serial number 2016-103530 filed May 24, 2016, the contents of which are incorporated herein by reference in their entirety for all purposes.

### STATEMENT REGARDING FEDERALLY SPONSORED RESEARCH OR DEVELOPMENT

Not applicable.

### BACKGROUND

The disclosure relates to a fuel passage structure of a fuel supply device that supplies fuel from a fuel tank to an internal combustion engine.

Japanese Laid-Open Patent Publication No. 2015-45275 discloses a fuel passage structure of a fuel supply device that supplies fuel from a fuel tank to an internal combustion engine. The fuel passage structure includes a passage-forming member, which forms a fuel passage for delivering pressurized fuel discharged from a fuel pump to an internal combustion engine, and a check valve for preventing backflow of the pressurized fuel within the fuel passage. The check valve maintains residual-pressure of the fuel within the fuel passage when the fuel pump operation is stopped.

In the publication, a check valve may comprise, for example, a valve body that can close the valve under its own weight. The valve body of the publication is arranged in a vertical passage, where the vertical passage forms a vertically extending portion of a fuel passage. The vertical passage extends upwardly at a downstream side of the check valve, where the height of the fuel passage structure in a vertical direction is high. As a result, this causes harmful effects on the installability of the fuel supply device. Accordingly, there is a need for an altered fuel passage structure that includes a check valve with a valve body capable of closing valve under its own weight, where the height of the fuel passage structure in a vertical direction is substantially lower than the prior art.

### SUMMARY

According to one aspect of the present disclosure, a fuel passage structure of a fuel supply device is configured to supply fuel stored in a fuel tank to an internal combustion engine. The fuel passage structure comprises a passage-forming member(s), which forms a fuel passage for delivering pressurized fuel discharged from a fuel pump to an internal combustion engine, and a check valve for preventing backflow of the pressurized fuel within the fuel passage. The fuel passage formed by the passage-forming member includes both a vertical passage extending in a vertical direction and lateral passages extending in a horizontal direction. The check valve is disposed at an intersection of the vertical and lateral passages. The check valve includes a valve body configured to close under its own weight. The valve body is movably arranged within the vertical passage in the vertical direction. The check valve is provided with a restriction member that restricts movement of the valve body from the intersection to the lateral passages without disturbing a forward flow of the pressurized fuel.

The restriction member can restrict the movement of the valve body toward the lateral passages without disturbing the forward flow of the pressurized fuel. Further, a conventional vertical passage that extends upwardly at a downstream side below the check valve may be eliminated. In this way, the height of the fuel passage structure in the vertical direction may be reduced while the check valve has a valve body capable of closing the valve under its own weight.

According to another aspect of the invention, the restriction member may include a filter member for filtering the pressurized fuel. Therefore, the filter member can filter the pressurized fuel passing through the restriction member. Consequently, it is possible to prevent foreign particles from flowing out of the filter member toward the downstream side.

According to another aspect of the invention, the fuel passage structure may include a jet pump for transferring the fuel stored in the fuel tank into a sub-tank. A branch passage is formed at the passage-forming member. The branch passage is branched off from the vertical passage between the fuel pump and the check valve, and feeds the fuel to the jet pump. Therefore, the branch passage may be configured without adding any new components because the branch part is formed by altering the structure of the passage-forming member.

According to another aspect of the invention, the fuel passage structure may include a pressure regulator for adjusting fuel pressure of the pressurized fuel which is supplied to the internal combustion engine. In this aspect, the passage-forming member is formed to have a second lateral passage that extends from an upper end of the vertical passage in a horizontal direction and delivers the pressurized fuel to the pressure regulator. The second lateral passage can thereby deliver the pressurized fuel to the pressure regulator without increasing the height of the fuel passage structure in the vertical direction. The second lateral passage may be configured without adding any new components because the second lateral passage is formed by altering the structure of the passage-forming member.

### BRIEF DESCRIPTION OF THE DRAWINGS

For a detailed description of the preferred embodiments of the invention, reference will now be made to the accompanying drawings.

FIG. 1 is a cross-sectional view of a fuel supply device;

FIG. 2 is a cross-sectional view of a fuel passage structure;

FIG. 3 is a perspective view of a restriction member;

FIG. 4 is a cross-sectional view of the fuel supply device according to another embodiment;

FIG. 5 is a perspective view of the restriction member for the fuel passage structure in FIG. 4;

FIG. 6 is a cross-sectional view of the fuel passage structure according to another embodiment;

FIG. 7 is a perspective view of a restriction member for the fuel passage structure in FIG. 6;

FIG. 8 is a cross-sectional view of the fuel passage structure according to another embodiment; and

FIG. 9 is a cross-sectional view of the fuel passage structure according to another embodiment.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. Any reference to up or down in the description and the claims will be made for purposes of clarity, with “up”, “upper”, “upwardly” or “upstream” meaning toward the surface of the borehole and with “down”, “lower”, “downwardly” or “downstream” meaning toward the terminal end of the borehole, regardless of the borehole orientation.

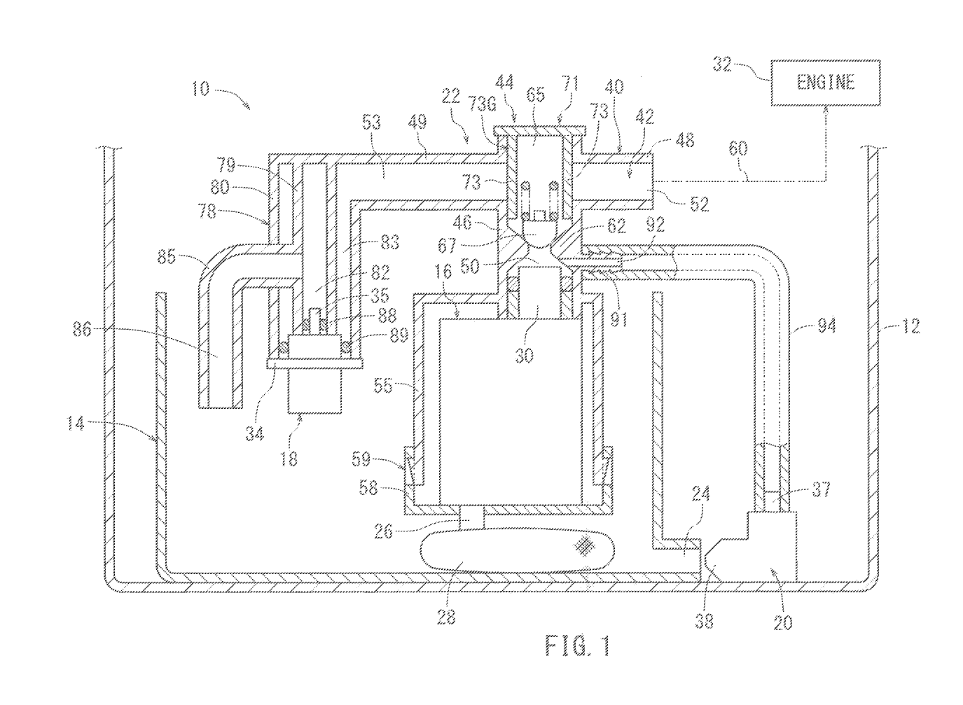

An exemplary embodiment according to the present disclosure will now be described with reference to the drawings. As shown in FIG. 1, a fuel supply device 10 is provided in a fuel tank 12 which is mounted on a vehicle (e.g., an automobile). The fuel supply device 10 serves to supply fuel stored in the fuel tank to an engine 32 (e.g., an internal combustion engine). In FIG. 1, an upper-lower direction corresponds to a vertical direction (i.e., an upper-lower direction of the fuel tank which is mounted on the vehicle).

As shown in FIG. 1, the fuel supply device 10 is provided within the fuel tank 12 for storing liquid fuel as fuel. The fuel tank 12 is a hollow container. A sub-tank 14, a fuel pump 16, a pressure regulator 18, a jet pump 20 and a fuel passage device 22 etc. are integrally modularized to comprise the fuel supply device 10. The sub-tank 14 is a cup-shaped container with an open upper surface. The sub-tank 14 is disposed on and abuts a bottom surface of the fuel tank 12. A fuel inlet port 24 is formed on the bottom-right side surface of the sub-tank 14 to open rightward in a lateral direction.

The fuel pump 16 is configured as an in-tank type fuel pump integrally formed with a motor. The fuel pump 16 includes an electric motor and a pump provided below the motor. The fuel pump 16 is mounted vertically within the sub-tank 14. A fuel suction port 26 extends from a lower end surface of the fuel pump 16. A fuel filter 28 is connected to the fuel suction port 26 to filter the fuel sucked by the fuel pump 16. A fuel outlet port 30 extends from an upper end surface of the fuel pump 16.

The pressure regulator 18 adjusts pressure of fuel supplied by the fuel pump 16 to the engine 32. The pressure regulator 18 has a cylindrical outer profile and a flange 34 extending annularly around the profile. A surplus fuel outlet port 35 extends from an upper end surface of the pressure regulator 18. The pressure regulator 18 introduces the pressurized fuel to be supplied to the engine 32, and additionally discharges the surplus fuel (return fuel) caused by fuel pressure adjustment through the surplus fuel outlet port 35.

As shown in FIG. 1, the jet pump 20 is arranged on a bottom surface of the fuel tank 12. The jet pump 20 includes an introduction port 37 for introducing the pressurized fuel that is used for driving an engine, and a nozzle 38 for discharging the fuel. The nozzle 38 is arranged to face the fuel introduction port 24 of the sub-tank 14. The nozzle 38 ejects the pressurized fuel toward the fuel introduction port 24 of the sub-tank 14. The stream of the pressurized fuel ejected from the nozzle 38 injects the fuel outside of the sub-tank 14 that is stored in the fuel tank 12 into the sub-tank 14 through the fuel introduction port 24. The fuel outside of the sub-tank 14 and the pressurized fuel ejected from the nozzle 38 are thereby injected into the sub-tank 14. That is to say, the jet pump 20 transfers the fuel that is stored within the fuel tank 12 outside of the sub-tank 14, into the sub-tank 14 utilizing the stream of the fuel that is ejected from jet pump 20.

The fuel passage device (fuel passage structure) 22 includes a passage-forming member 40 and a check valve 44. The passage-forming member 40 forms a fuel passage 42 for delivering the pressurized fuel, which is discharged from the fuel pump 16, to the engine 32. The check valve 44 prevents the backflow of the pressurized fuel from within the fuel passage 42. The passage-forming member 40 connects the fuel pump 16, the pressure regulator 18 and the jet pump 20.

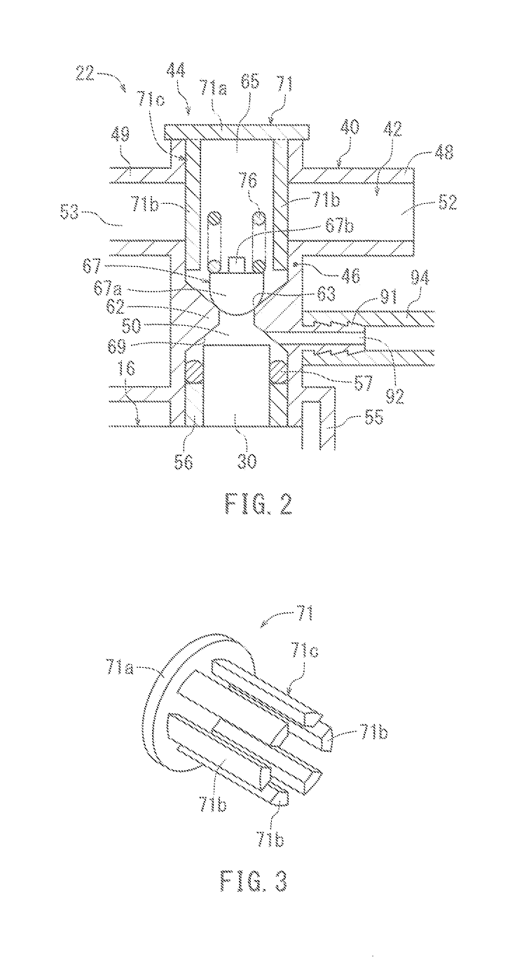

As shown in FIG. 2, the passage-forming member 40 has a T-pipe configuration having a hollow cylindrical vertical pipe 46 and two hollow cylindrical lateral pipes 48 and 49. The vertical pipe 46 extends in a vertical direction. The lateral pipes 48 and 49 intersect an upper end of the vertical pipe 46 and extend in opposite horizontal directions, respectively. A vertical passage 50 extending in the vertical direction is formed within the vertical pipe 46. Both the upper and lower ends of the vertical pipe 46 are open. A lateral passage 52 extending from the upper end of the vertical passage 50 in a horizontal direction (from left to right in FIG. 2) is formed within the lateral pipe 48. The vertical passage 50 and the lateral passage 52 define the fuel passage 42.

A branch passage 53 extending from the upper end of the vertical passage 50 in the horizontal direction (from right to left in FIG. 2) is formed within the lateral pipe 49. The branch passage (lateral passage) 53 serves to supply the fuel to the pressure regulator 18.

As shown in FIG. 1, a pump casing 55 that has an upside down U-shape is integrally formed with the lower end of the vertical pipe 46. The fuel pump 16 is inserted and accommodated in the pump casing 55. The fuel outlet port 30 of the fuel pump 16 is inserted into the lower end of the vertical pipe 46, at the upper end of casing 55. As shown in FIG. 2, a collar 56 and an O-ring 57 are interposed between the fuel outlet port 30 and the vertical pipe 46. The O-ring 57 resiliently seals the lower outer radial peripheral space with respect to outlet port 30, between the fuel outlet port 30 and the vertical pipe 46.

As shown in FIG. 1, a U-shaped receiving member 58 for receiving the lower end of fuel pump 16 is attached at the lower end of the pump casing 55, where the top portion of the receiving member 59 attaches to the lower end of casing 55 by a snap-fit configuration 59. One end of a fuel supply passage 60 is connected to an end of the lateral pipe 48. The other end of the fuel supply passage 60 is connected to an engine 32, more specifically, a delivery pipe of the engine having injectors (fuel injection valves). Each injector injects the fuel into each combustion chamber of the engine. Therefore, the pressurized fuel discharged from the fuel pump 16 is supplied to the engine 32 via the fuel supply passage 60 after passing through the vertical passage 50 and the lateral passage 52 of the fuel passage 42.

As shown in FIG. 2, the check valve 44 is disposed in the intersection part of the vertical passage 50 and the lateral passage 52. A throttle part 62 of the vertical pipe 46 for narrowing a passage area is formed within the vertical passage 50 proximal to and below the intersection of the passages 50 and 52. The throttle part 62 is disposed above the fuel outlet port 30 of the fuel pump 16. A valve seat 63 is formed on the upper surface of the throttle part 62 that is defined by a tapered surface with a gradually increasing diameter in the down-to-up direction. The valve chamber 65 is defined as comprising the intersection above the valve seat 63 of the vertical passage 50, the lateral passage 52, and the branch passage 53.

A valve body 67 of the check valve 44 is arranged in the valve chamber 65 in a movable manner, i.e., openable/closable in the vertical direction. The valve body 67 is designed as a poppet valve made of a rubber elastic material. The valve body 67 includes a hemispherical valve portion 67a in the shape of a lower hemisphere and a short shaft 67b extending from an upper end surface of the valve portion 67a. The valve body 67 can sit on the valve seat 63 such that it closes the valve under its own weight. A fuel guide surface 69 is formed on a lower surface of the throttle part 62 that is defined by a tapered surface with a gradually increasing diameter toward the lower side.

A valve body 67 that can move in the vertical direction to close the valve by its own weight is arranged in the valve chamber 65. The valve body 67 may potentially be pushed out of the valve chamber 65 by the pressurized fuel when the valve body 67 is largely shifted toward the lateral passage 52 or the branch passage 53. In order to prevent the valve body 67 from being largely shifted, a restriction member 71 is provided at the check valve 44. The restriction member 71 restricts the movement of the valve body 67 into the lateral passage 52 as well as the branch passage 53, without disturbing a forward flow of the pressurized fuel.

As shown in FIG. 3, the restriction member 71 is made of resin and includes a disc-shaped cover plate 71a and restriction ribs 71b. The restriction member 71 comprises a plurality of restriction ribs 71b (for example, six ribs are shown in FIG. 3), which are bar-shaped and extend from a lower surface of the cover plate 71a. The plurality of the restriction ribs 71b are arranged concentrically with respect to the cover plate 71a at uniform intervals in a circumferential direction, at a uniform radial length from the center of plate 71a. The plurality of restriction ribs 71b are arranged on the cover plate 71a in a circular manner, with a uniform radial length, so that the restriction member 71 is formed to have a cylindrical appearance. As a result, the restriction member 71 has a cap shape. An outer diameter of the plurality of restriction ribs (where the plurality of restriction ribs is shown with a reference numeral 71c) formed by the plurality of restriction ribs 71b is configured to have the same diameter or substantially the same diameter as an inner diameter of the vertical pipe 46.

As shown in FIG. 2, the restriction member 71 is attached to the upper end of the vertical pipe 46 to close the upper end opening of the vertical pipe 46. The cover plate 71a of the restriction member 71 contacts the upper end of the vertical pipe 46. When the restriction member 71 is so attached, the plurality of restriction ribs 71c is inserted into the vertical pipe 46 substantially without a radial gap, wherein the outer radial peripheral surface of the plurality of restriction ribs 71b is adjacent to the inner radial peripheral surface of the upper end of the pipe 46. The valve body 67 is movably arranged in the vertical direction within the area of chamber 65 bounded by the plurality of restriction ribs 71c. The restriction member 71 is fixed to the vertical pipe 46 by welding or bonding. The restriction member 71 can be fixed by caulking the upper end of the vertical pipe 46. Alternatively, the plurality of restriction ribs 71c may be press-fitted into the vertical pipe 46.

The plurality of restriction ribs 71c is also arranged to extend vertically across an opening end that is defined at the intersection of the vertical passage 52 and the branch passage 53 near the valve chamber 65. A circumferential gap between the mutually adjacent restricting ribs 71b serves as a passage opening through which the pressurized fuel can flow. Therefore, through the presence of the circumferential gap where fuel is still able to flow, the valve body 67 is prevented from shifting toward the lateral passage 52 and the branch passage 53 without disturbing the forward flow of the pressurized fuel. A cushion spring 76 such as a coil spring is arranged on the valve portion 67a of the valve body 67 while being fitted therein. The cushion spring 76 contacts the cover plate 71a of the restriction member 71 when the valve body 67 is lifted by pressurized fuel to its highest position.

As shown in FIG. 1, the upper end of a vertically extending connection pipe 78 is connected to the end of the lateral pipe 49 of the passage-forming member 40. The connection pipe 78 is integrally formed with the lateral pipe 49. The connection pipe 78 includes an inner pipe 79 and an outer pipe 80, which jointly form a configuration of double inner and outer cylinders, respectively. A lower end of each of the inner and outer pipes 79 and 80 is opened, while the upper end is closed. An inner passage 82 is defined within the inner pipe 79. An outer passage 83 is defined in a tubular space between the inner pipe 79 and the outer pipe 80. An upper end of the outer passage 83 communicates with the branch passage 53. An outlet pipe 85 is an elbow pipe. The outlet pipe 85 is connected to the inner pipe 79 and extends radially outward from the inner pipe 79 through the outer pipe 80. An end of the outlet pipe 85 is opened downward from the radial outward extension. An outlet passage 86 is formed within the outlet pipe 85.

A pressure regulator 18 is connected at a lower end of the connecting pipe 78. An upper part of the pressure regulator 18 is inserted into the outer pipe 80. The surplus fuel outlet port 35, extending upward from the upper end surface of the pressure regulator 18 is inserted into the lower end of the inner pipe 79. The flange 34 contacts the lower end of the outer pipe 80. An O-ring 89 is interposed radially between the pressure regulator 18 and the outer pipe 80 for eliminating radial clearance between, and resiliently sealing, these two members. Similarly, an O-ring 88 is interposed between the surplus fuel outlet port 35 and the inner pipe 79 for eliminating radial clearance between, and resiliently sealing, these two members.

The pressure regulator 18 is fixedly supported at the connecting pipe 78 by a supporting member (not shown). Pressurized fuel discharged from the fuel pump 16 flows toward the pressure regulator 18 passing through the vertical passage 50 and the branch passage part 53. The pressurized fuel is then introduced into the pressure regulator 18 through the outer passage 83. Subsequently, the surplus fuel flows out of the surplus fuel outlet port 35 of the pressure regulator 18, and is discharged from the inner passage 82 through the outlet passage 86.

As shown in FIG. 2, a branch pipe 91 is formed at the vertical pipe 46 of the passage-forming member 40 and extends laterally from the vertical pipe 46. The branch pipe 91 is positioned between the fuel pump 16 and the check valve 44. A branch passage 92 is defined within the branch pipe 91 that branches off from the vertical passage 50 between the fuel pump 16 and the check valve 44.

As shown in FIG. 1, an introduction port 37 of the jet pump 20 communicates with the branch pipe 91 via a tube (piping member) 94. The pressurized fuel within the vertical pipe 46 between the fuel pump 16 and the check valve 44 is supplied to the jet pump 20 through the branch passage 92 and the tube 94. The pressurized fuel flowing from the vertical passage 50 to the branch passage 92 is used for the jet pump 20.

Typically, a check valve for maintaining residual pressure is incorporated in the fuel outlet port 30 of the fuel pump 16. In addition to this check valve, the fuel supply device 10 includes the check valve 44 for maintaining residual pressure in and downstream of the valve chamber 65. The check valve 44 is arranged in the fuel passage 42 downstream of the branching part of the branch passage 92. In this way, the check valve 44 can maintain the residual pressure of the fuel that is supplied to the engine 32 through the fuel passage 42.

The fuel stored in the sub-tank 14 is sucked into the fuel pump 16 through the fuel filter 28 when the fuel pump 16 is driven. The pressurized fuel discharged from the fuel outlet port 30 of the fuel pump 16 passes via the vertical passage 50 of the fuel passage 42, defined in the passage-forming member 40, and is supplied to the engine 32 from the lateral passage 52 of the fuel passage 42 through the fuel supply passage 60. At this time, as fuel flows upward through the vertical passage 50, the check valve 44 opens as the valve body 67 is pushed up by the forward flow of the pressurized fuel.

The pressure regulator 18 adjusts the pressure of the pressurized fuel to be supplied from the fuel pump 16 to the engine 32. The pressure regulator 18 discharges the surplus fuel (return fuel) through the surplus fuel outlet port 35 to adjust the pressure of the pressurized fuel. The surplus fuel flows through the inner passage 82 and donward through the outlet passage 86 to be discharged from the fuel supply device 10.

The pressurized fuel deviated from the vertical passage 50 through the branch passage portion 92 is supplied to the jet pump 20 through the tube 94. The jet pump 20 then transfers this pressurized fuel along with the fuel that is stored in the fuel tank 12 outside of the sub-tank 14 into the sub-tank 14 utilizing the stream of the supplied pressurized fuel.

The valve body 67 of the check valve 44 is pushed downward under its own weight, such that the valve body 67 sits on valve seat 63 and closes the valve 44. This maintains the residual pressure of the fuel in the lateral passage 52 and the branch passage 53, downstream of the valve body 67, while the fuel pump 16 is stopped. In this manner, through the weight bias of the valve body 67, enabling blockage of the valve seat 63, the backflow of the fuel from the fuel passage 42 to the jet pump 20 may be prevented. As a result, the residual pressure downstream of the valve body 67, within the valve chamber 65, the lateral passage 52, the branch passage 53 and the fuel supply passage 60, is maintained.

As shown in FIG. 2, the fuel passage device 22 does not need a conventional vertical passage that extends upwardly at a downstream side of the check valve 44. That is, the restriction member 71 provided to the check valve 44 may limit the movement of the valve body 67 toward the lateral passage 52, while at the same time the restriction member 71 may not inhibit the forward flow of the pressurized fuel. Therefore, the vertical height of the fuel passage device 22 can be reduced where the check valve 44 has valve body 67 capable of closing under its own weight.

As shown in FIG. 2, the branch passage 92 is branched off from the vertical passage 50 midstream between the fuel pump 16 and the check valve 44. A part of the pressurized fuel within the vertical passage 50 flow through this branched off passage 92, and may flow into the jet pump 20. Therefore, the branch passage 92 may be provided without needing to increase the height of the fuel passage device 22. The branch passage 92 is formed at the passage-forming member 40. Therefore, the branch passage 92 may be provided without any additional new components.

As shown in FIG. 2, because the branch passage 53 extends from the upper end of the vertical passage 50 in a completely horizontal direction, where the direction of extension does not have a vertical component, the branch passage 53 may be provided without increasing the height of the fuel passage device 22 in the vertical direction. Further, a part of the pressurized fuel supplied to the engine 32 may be branched off at the branch passage 53, and may flow into the pressure regulator 18. The branch passage 53 (including connecting pipe 78) may be provided without any additional new components since the branch passage 53 is integrally formed with the passage-forming member 40.

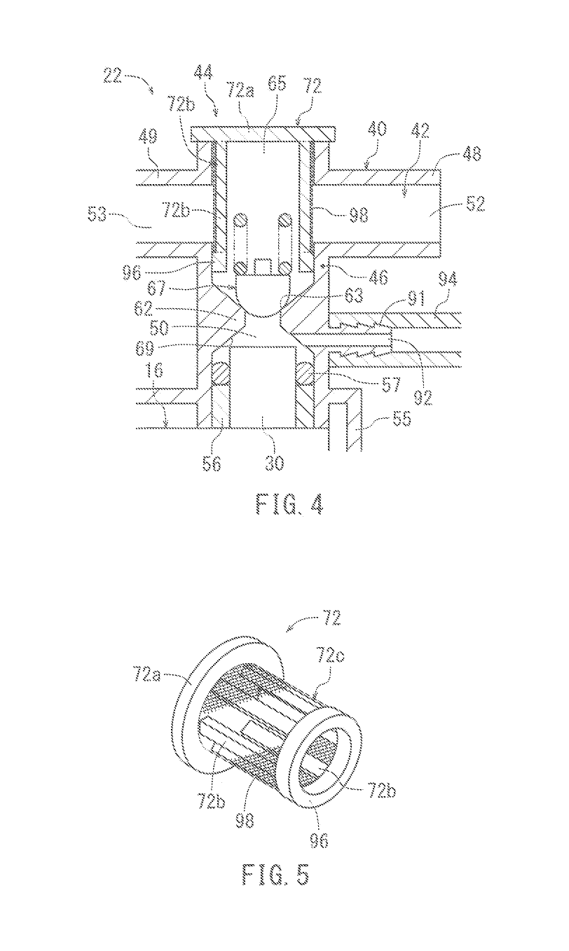

As shown in FIGS. 4 and 5, the fuel passage device 22 may include a restriction member 72 instead of the restriction member 71 shown in FIGS. 2 and 3. As shown in FIG. 5, the restriction member 72 includes a cover plate 72a and a plurality of restriction ribs 72b (where the plurality of restriction ribs 72b is denoted by 72c) similar to the cover plate 71a and the restriction ribs 71b (where the plurality of restriction ribs is denoted by 71c) shown in FIG. 3. The restriction member 72 further includes an annular press-fitted member 96. The press-fitted member 96 is attached to the ends of the restriction ribs 72b such that the ends of a plurality restriction ribs 72b are connected in the circumferential direction. The press-fitted member 96 includes an outer diameter slightly larger than an inner diameter of the vertical pipe 46, such that the restriction member 72 may be press-fitted into the vertical passage 50. The outer diameter of the plurality of restriction ribs 72c is configured to have a slightly smaller diameter than the inner diameter of the vertical pipe 46.

A sheet-like filter member 98 is wound around the entire outer peripheral circumferential surface of the plurality of restriction ribs 72c and fixed, for example, by an adhesive. The filter member 98 is formed of, for example, a metal mesh material.

As shown in FIG. 4, the restriction member 72 is attached to the passage-forming member 40. The press-fitted member 96 press-fit into the vertical pipe 46 may ensure a sealing property between the restriction member 72 and the passage-forming member 40 through the press-fit fastening. The filter member 98 is interposed radially between the plurality of restriction ribs 72c and the vertical pipe 46.

As shown in FIG. 4, the filter member 98 may filter the pressurized fuel flowing forward and passing through the circumferential gap (flow-through opening) between adjacent restriction ribs 72b. The filter member 98 may thereby prevent foreign particles from flowing through the filter member 98 and to the downstream side of the valve chamber 65. As a result, it is possible to prevent foreign particles from flowing out into the engine 32 and the pressure regulator 18. The foreign particles may be abrasion powder generated at a brush and a bearing of the fuel pump 16.

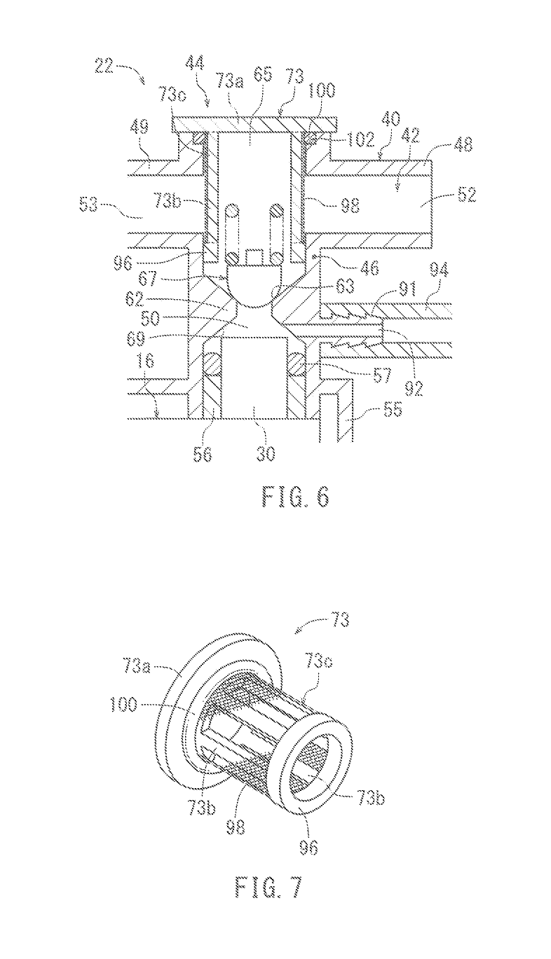

As shown in FIGS. 6 and 7, the fuel passage device 22 may have a restriction member 73 instead of the restriction member 72 shown in FIGS. 4 and 5. As shown in FIG. 7, the restriction member 73 includes a cover plate 73a and a plurality of restriction ribs 73b (where the plurality of restriction ribs 73b is denoted by 73c) similar to the cover plate 72a and the restriction ribs 72b shown in FIG. 5. The restriction member 73 further includes the press-fitted member 96 and the filter member 98 similar to the restriction member 72 shown in FIG. 5.

As shown in FIGS. 6 and 7, the restriction member 73 includes an O-ring 100 fitted to a basal upper end of the plurality of restriction ribs 73c. The restriction member 73 is attached to the passage-forming member 40. A stepped groove 102 is formed at the inner periphery of the vertical pipe 46 along the circumference of the upper end opening of the vertical pipe 46. The O-ring 100 is fitted into the stepped groove 102. The O-ring 100 eliminates radial clearance between, and resiliently seals, the cover plate 73a of the restriction member 73 and the vertical passage 50.

As shown in FIG. 6, the restriction member 73 may be removably attached to the passage-forming member 40. In this way, the restriction member 73 can be used as a replacement component. For example, the restriction member 73 may be attached to the passage-forming member 40 in a snap-fit configuration. In this construction, the restriction member 73 may be easily replaced.

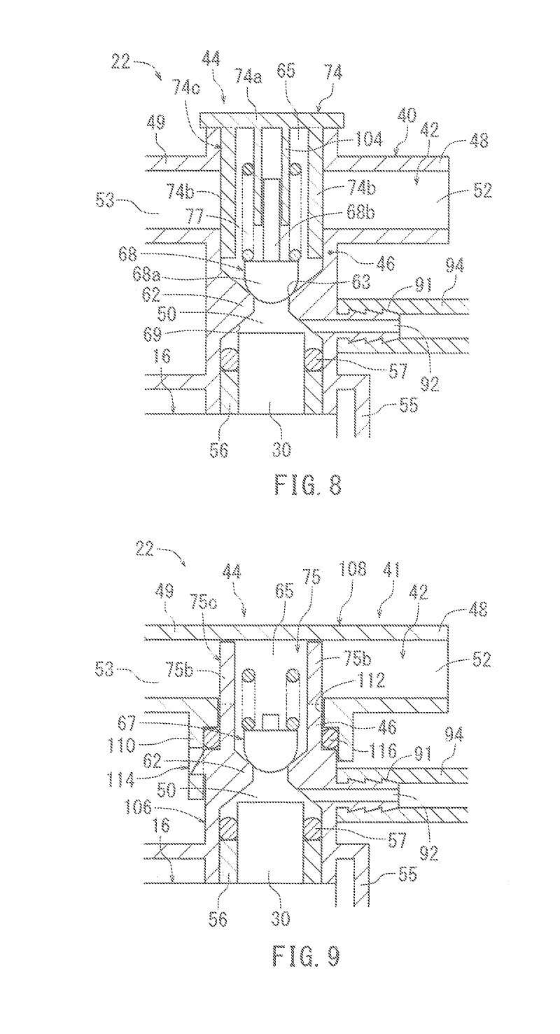

As shown in FIG. 8, the fuel passage device 22 may include a valve body 68 and a restriction member 74 instead of the valve body 67 and the restriction member 71 shown in FIG. 2. As shown in FIG. 8, the valve body 68 includes a valve portion 68a and a long shaft 68b. The valve portion 68a is configured similar to the valve portion 67a shown in FIG. 2. The long shaft 68b is longer than the short shaft 67b shown in FIG. 2 in an axial direction.

As shown in FIG. 8, the restriction member 74 includes a cover plate 74a and restriction ribs 74b (where a plurality of restriction ribs 74b is denoted by 74c) similar to the cover plate 71a and the restriction ribs 71b shown in FIGS. 2 and 3. The restriction member 74 further includes a hollow cylindrical shaft 104 extending downwardly from the cover plate 74a. The long shaft 68b of the valve body 68 is movably inserted into the cylindrical shaft 104 in an axial direction i.e., vertical direction. A cushion spring 77 may be installed on the upper surface of the valve portion 68a of the valve body 68. The cushion spring 77 is a coil spring that is longer than the long shaft 68b.

As shown in FIG. 8, the hollow cylindrical shaft 104 of the restriction member 71 may guide the long shaft 68b of the valve body 68 in the axial direction. Accordingly, with the radial barrier to movement provided by the shaft 104, the valve body 68 moves linearly in the vertical direction. Therefore, in this embodiment, the restriction ribs 74b may be eliminated or the number of the restriction ribs 74b may be reduced.

As shown in FIG. 9, the fuel passage device 22 may include a passage-forming member 41 and the restriction member 75 instead of the passage-forming member 40 and the restriction member 71 shown in FIG. 2. As shown in FIG. 9, the passage-forming member 41 has a two-split structure including a main member 106 and an auxiliary member 108. The main member 106 includes the vertical pipe 46 and the pump casing 55. The auxiliary member 108 includes the lateral pipes 48 and 49 and the connecting pipe 78 shown in FIG. 1. The lateral pipes 48 and 49 are contiguous in series.

As shown in FIG. 9, the restriction member 75 is integrally formed with an upper end of the vertical pipe 46 of the main member 106. The restriction member 75 includes restriction ribs 75b (restriction rib group 75c) similar to the restriction ribs 71b (plurality of restriction ribs 71c) shown in FIGS. 2 and 3. A downwardly extending cylindrical connecting pipe 110 is integrally formed at a lower side of the continuous portion of the lateral pipes 48 and 49. A fitting hole 112 concentric with the connecting pipe 110 is formed at the lower side of the continuous portion of the lateral pipes 48 and 49. The fitting hole 112 has a slightly smaller hole diameter than an inner diameter of the connecting pipe 110.

As shown in FIG. 9, the plurality of restriction ribs 75c is inserted into the fitting hole 112 of the auxiliary member 108. The vertical pipe 46 is inserted in the connecting pipe 110 and the fitting hole 112. The ends (upper ends) of each restriction rib 75b contact or closely contact the upper side of an inner wall surface of the lateral pipe 48. The vertical pipe 46 and the connecting pipe 110 are attached to each other in a snap fit configuration 114. An O-ring 116 is interposed between the vertical pipe 46 and the connecting pipe 110 for eliminating radial clearance between and resiliently sealing these two members.

The embodiment shown in FIG. 9 may exhibit the same function and effect as those of the embodiment shown in FIG. 2. The filter member 98 in FIGS. 4 and 5 may be mounted at the outer periphery of the plurality of restriction ribs 75c in FIG. 9.

The valve bodies 67 and 68 include hemispherical valve portions 67a and 68a. Alternatively, the entire valve body may be formed in a spherical shape.

The various examples described above in detail with reference to the attached drawings are intended to be representative of the present invention and thus non limiting embodiments. The detailed description is intended to teach a person of skill in the art to make, use and/or practice various aspects of the present teachings and thus does not limit the scope of the invention in any manner. Furthermore, each of the additional features and teachings disclosed above may be applied and/or used separately or with other features and teachings in any combination thereof, to provide improved fuel passage structure for a fuel supply device, and/or methods of making and using the same.

What is claimed is:

1. A fuel passage structure of a fuel supply device for supplying fuel stored in a fuel tank to an internal combustion engine, the fuel passage structure comprising:
a passage-forming member including a fuel passage for delivering pressurized fuel discharged from a fuel pump to the internal combustion engine; and
a check valve configured to prevent backflow of the pressurized fuel within the fuel passage; wherein:
the fuel passage includes a vertical passage extending in a vertical direction and a lateral passage extending in a horizontal direction,
the check valve is disposed at the intersection of the vertical passage and the lateral passage,
the check valve includes a valve body configured to close a valve seat opening under its own weight,
the valve body is configured to move within the vertical passage in the vertical direction, and
the check valve includes a restriction member configured to restrict movement of the valve body from the intersection into the lateral passage without disturbing a flow of the pressurized fuel from the vertical passage through the intersection and into the lateral passage.

2. The fuel passage structure of claim 1, wherein the restriction member includes a filter member for filtering the pressurized fuel.

3. The fuel passage structure of claim 1, further comprising a branch passage extending from the passage-forming member, wherein the branch passage is branched off from the vertical passage between the fuel pump and the check valve, and the branch passage is configured to supply the fuel to a jet pump that is configured to transfer the fuel stored in the fuel tank into a sub-tank.

4. The fuel passage structure of claim 1, further comprising a second lateral passage that extends from an upper end of the vertical passage in a horizontal direction, wherein the second lateral passage is configured to deliver the pressurized fuel to a pressure regulator that is configured to adjust fuel pressure of the pressurized fuel which is supplied to the internal combustion engine.

5. The fuel passage structure of claim 1, wherein the valve body has a U-shaped cross section including a hemispherical portion.

6. The fuel passage structure of claim 1, wherein the restriction member includes a plurality of uniformly circumferentially-spaced physical barriers configured to prevent the valve body from moving in the radial direction outward beyond a radius proximal to the center of the valve seat.

7. A fuel passage structure of a fuel supply device for supplying fuel stored in a fuel tank to an internal combustion engine, the fuel passage structure comprising:
a passage-forming member including a fuel passage for delivering pressurized fuel discharged from a fuel pump to the internal combustion engine, wherein the fuel passage includes a vertical passage extending in a vertical direction and a lateral passage extending in a horizontal direction;
a check valve disposed at an intersection of the vertical passage and the lateral passage, wherein the check valve is configured to prevent backflow of the pressurized fuel within the fuel passage, wherein the check valve includes a U-shaped hemispherical valve body movably disposed within the vertical passage and configured to move in the vertical direction under its own weight to close an annular valve seat; and
a restriction member positioned in the intersection and configured to restrict the movement of the valve body from the intersection to the lateral passage without disturbing flow of the pressurized fuel from the vertical passage through the intersection and into the lateral passage, wherein the restriction member includes a plurality of uniformly circumferentially-spaced physical barriers configured to prevent the valve body from moving in the radial direction outward beyond a radius proximal to the center of the valve seat.

8. A fuel passage structure of a fuel supply device for supplying fuel stored in a fuel tank to an internal combustion engine, the fuel passage structure comprising:
a passage-forming member comprising piping that forms a fuel passage for delivering pressurized fuel discharged from a fuel pump to the internal combustion engine, wherein the fuel passage includes a vertical passage extending in a vertical direction and a lateral passage extending in a horizontal direction proximal the top of the vertical passage;
a check valve disposed at the intersection of the vertical passage and the lateral passage and configured to prevent backflow of the pressurized fuel within the fuel passage, wherein the check valve includes a U-shaped hemispherical valve body configured to close an annular valve seat formed under and proximate to the lateral passage under the valve body's own weight, wherein the valve body is movably disposed within the vertical passage and is configured to move in the vertical direction; and
a restriction member provided at the check valve, wherein the restriction member comprises a disc-shaped cover plate with a plurality of circumferentially-spaced vertical ribs extending downwards from the plate, wherein the restriction member is press-fitted into the intersection of the vertical passage and the lateral passage, where the ribs of the restriction member are configured to restrict movement of the valve body from the intersection to the lateral passage without disturbing the flow of the pressurized fuel from the vertical passage to the lateral passage.

9. The fuel passage structure of claim 8, wherein the ribs of the restriction member are contiguous with the vertical and lateral passage such that each of the ribs' vertical length spans at least the entire width of the lateral passage.

10. The fuel passage structure of claim 8, wherein the valve body is a poppet made of rubber elastic material, wherein a coil spring is placed abutting the upper surface of the hemispherical valve body and is configured to provide resistance as the valve body moves in a downward-to-upward direction.

11. The fuel passage structure of claim 8, further comprising a second lateral passage oppositely facing the first lateral passage and extending in a horizontal direction near the top of the vertical passage, where the second lateral passage is configured to deliver the pressurized fuel to a pressure regulator that is configured to adjust fuel pressure of the pressurized fuel which is supplied to the internal combustion engine, where the ribs of the restriction member are contiguous with the vertical and both lateral passages such that each of the ribs' vertical length spans at least the entire width of both lateral passages.

12. The fuel passage structure of claim 11, wherein the restriction member further comprises a metal mesh filter member mounted at the outer periphery of the plurality of ribs such that it spans the entire circumferential direction, and when press-fit into the space comprising the intersection of the vertical passage and the lateral passage, the filter member is contiguous with the entire circumferential boundary of the vertical passage.

13. The fuel passage structure of claim 11, wherein the second lateral passage leads to a vertically extending connection pipe, which is connected to and formed integrally with a lateral pipe of the second lateral pipe, where the vertically extending connection pipe comprises an inner pipe and an outer pipe that are concentric, where the inner pipe has a smaller diameter than the outer pipe, wherein surplus fuel flows through the inner pipe and is ejected from the fuel passage structure.
